(19) United States
(12) Patent Application Publication
(10) Pub. No.: US 2005/0280260 A1
(43) Pub. Date: Dec. 22, 2005

(54) Hose connector of faucet

(76) Inventor: Legend Lu, Xiamen (CN)

Correspondence Address: CHARLES E. BAXLEY, ESQ., 90 JOHN STREET, THIRD FLOOR, NEW YORK, NY, 10038, US

(21) Appl. No.: 11/153,194

(22) Filed: Jun. 15, 2005

(30) Foreign Application Priority Data
Jun. 16, 2004 (CN) 200420047350.5

(51) Int. Cl. F16L 27/00

(52) U.S. Cl. 285/354

(57) ABSTRACT

The present invention relates to a hose connector of faucet for attaching spray head, which is comprised of a male swivel connector, a socket joint and a washer; the said male swivel connector and said washer are placed into said socket joint with the flange portion, wherein a metal sleeve is put over the flange portion of the male swivel connector under said washer, and an O-ring is set between the male swivel connector and the metal sleeve. As connecting the hose to the faucet outlet, put the combined socket joint on the tip end of the outlet, and turn the socket joint to make the outlet screw into the inside of the socket joint to extrude the washer to press the metal sleeve to carry out axial seal between the hose and the outlet; meanwhile the O-ring set between the male swivel connector and the metal sleeve can carry out radial seal between them so that the male swivel connector can turn freely in the socket joint relative to the metal sleeve, therefore the spray head with hose can move in all directions while operating.

### BACKGROUND OF THE INVENTION

1. Field of the Invention

The present invention relates to a hose connector of faucet, and more particularly to a hose connector connected to the second outlet of faucet to attach a spray head.

2. Description of Prior Art

So far, the conventional faucet used in home kitchen or bathroom is often attached a spray head with hose assembly for effectively washing fruits or something else. There is a connector fabricated at one end of the hose for connection with the second outlet of faucet.

Referring to FIG. 1, the conventional hose connector includes a male connector 1′, a socket joint 2′ and a washer 3′; said male connector 1′ has a water passage hole 11′ formed at central, and an extended portion plugged and secured into the end of the hose A, and a back end with a flange 12′ for matching into the socket joint 2′; said socket joint 2′ is put over the male connector 1′ stopping on the flange 12′ with a stage shoulder 22′ of the through-hole 21′, and a female thread 23′ formed on upper portion of socket joint 2′ for matting with the second outlet of faucet; the washer 3′ is made of rubber, and placed into the inside of the through-hole 21′. As connecting the hose A to the faucet outlet, just need to turn socket joint 2′ so as to make the outlet secure into the inside of the socket joint 2′ axially to extrude the washer 3′ to touch against the male connector 1′ so as to carry out seal function between the hose A and the outlet.

Cooperating to reference with FIG. 5, the hose A is in bend or tie-in state at rest, as tending to use, the hose A is kept into bigger rigidity under water pressure so that the movement of spray head in different directions becomes hard because of static connection between hose connector and faucet second outlet.

### OBJECTS AND SUMMARY OF THE INVENTION

It is therefore a main object of the present invention to provide a hose connector, so that the hose A can rotate around the faucet second outlet axially facilitating to move around the spray head while using.

For achieving the object, the present invention provides technique project is to provide a hose connector comprised of a male swivel connector, a socket joint and a washer; said male swivel connector and said washer are placed into said socket joint with the flange portion, wherein a metal sleeve is put over the flange portion of the male swivel connector under said washer, and an O-ring is set upon between the outside wall of male swivel connector and the metal sleeve.

Said metal sleeve possesses a settlement for fitting the upper portion of the male swivel connector.

The depth of the settlement of said metal sleeve should be bigger than the thickness of the flange portion of the male swivel connector.

Said flange portion of the male swivel connector is cut into a ring groove on the outside wall.

By means of the above-mentioned technique project, because the metal sleeve is located between the washer and the male swivel connector, as connecting the hose to the faucet outlet, put the combined socket joint on the tip end of the faucet outlet, and turn the socket joint to make the outlet screw into the inside of the socket joint to extrude the washer to press the metal sleeve to carry out axial seal between the hose and the outlet; meanwhile the O-ring set upon the male swivel connector and the metal sleeve can carry out radial seal between them so that the male swivel connector can turn freely in the socket joint relative to the metal sleeve, therefore the spray head with hose can move in all directions while operating.

### BRIEF DESCRIPTION OF THE DRAWINGS

FIG. 1 is a solid exploded view of the prior art.

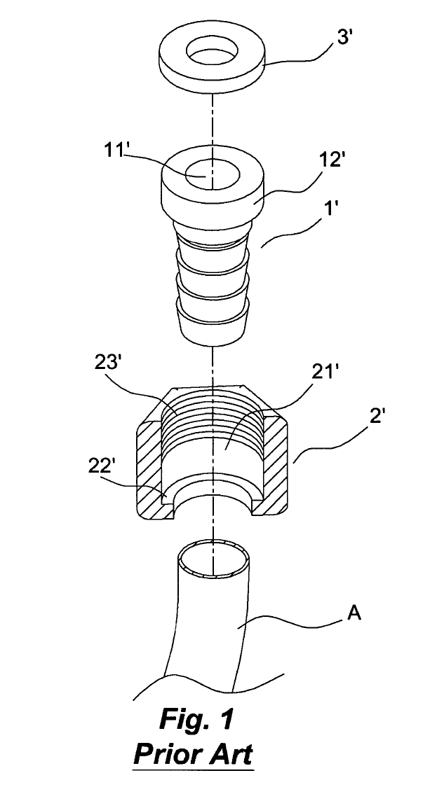

FIG. 2 is a solid exploded view of the present invention.

FIG. 3 is a cross-section view showing the combination state of the present invention.

FIG. 4 is a cross-section view showing the combination state of another embodiment of the present invention.

FIG. 5 is a solid view showing the using state of the hose connector.

### DETAILED DESCRIPTION OF PREFERRED EMBODIMENTS

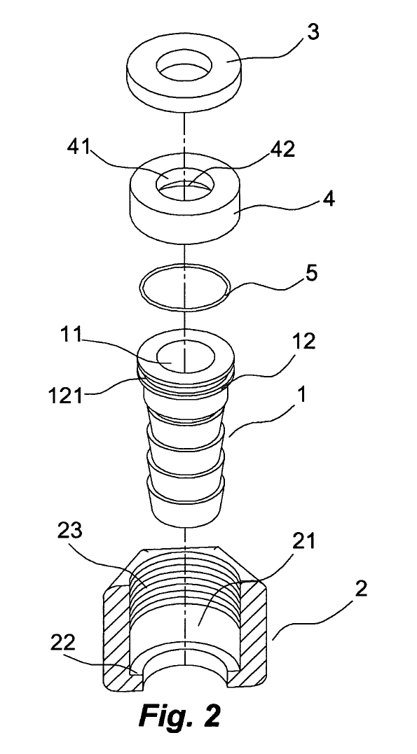

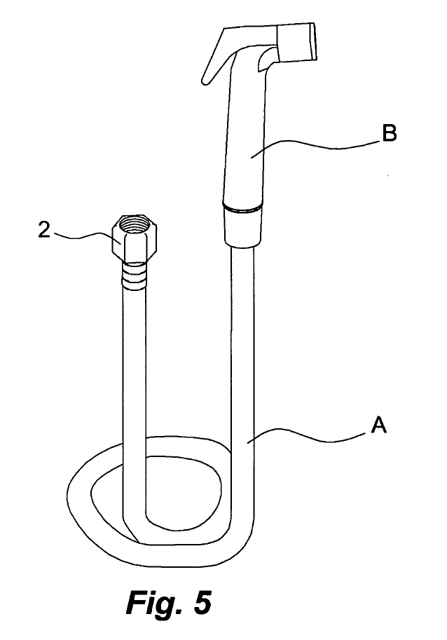

Firstly, referring to FIG. 2 cooperating to FIG. 5, the present invention provides a hose connector comprised of a male swivel connector 1, a socket joint 2, a washer 3, a metal sleeve 4 and an O-ring 5.

Said male swivel connector 1 has a water passage hole 11 formed at central, and the extended portion plugged and secured into the end of the hose A, and a back end with a flange 12 for matching into the socket joint 2, and a ring groove 121 cut on the outside wall of the flange 12;

Said socket joint 2 possesses a central through-hole 21 and a stage shoulder 22 formed on the low portion for matching to said flange 12 of the male swivel connector 1, and a female thread 223 formed on the inner side at the low portion for screwing on the outlet;

Said washer 3 is made of rubber;

Said metal sleeve 4 possesses a central water-passage hole 41 with a settlement 42 that is a bit thicker than the thickness of the flange portion 12 of the male swivel connector 1; said settlement 42 mates to the flange 12 of the male swivel connector 1 in clearance fit;

Said O-ring 5 is made of rubber.

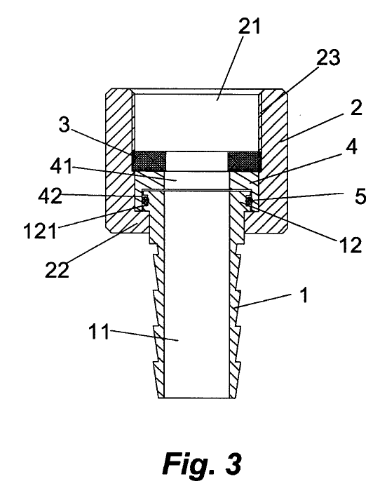

In combination, as shown in FIG. 3, said male swivel connector 1 is passed through the socket joint 2 until the flange 12 mates into the stage shoulder 22; said O-ring 5 is preset into the ring groove 121 of the flange 12; then put said metal washer 4 into said socket joint 2 over said male swivel connector 1 so that the flange 12 just extra fit into the settlement 42, and said O-ring just seals between the male swivel connector 1 and the metal sleeve 4; meanwhile one end of the metal sleeve 4 touches against the block stage shoulder 22; next said washer 3 is put on the metal sleeve 4 in the inside of the through-hole 21 of the socket joint 2.

Referring to FIG. 5, as connecting the hose A to the outlet, put the combined socket joint 2 on the end of the outlet, and turn the socket joint 2 to make the outlet screw into the inside of the socket joint 2 to extrude the washer 3 to press the metal sleeve 4; because the depth of the 42 is bigger than the thickness of the flange 12, the male swivel connector 1 with the O-ring can swivel freely in the settlement 42

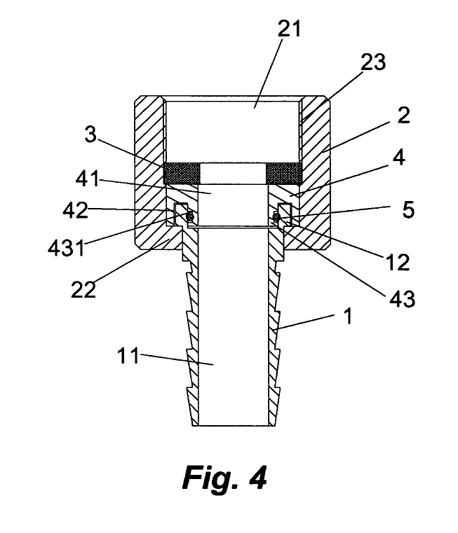

Referring to FIG. 4, showing another embodiment of the present invention. Said metal sleeve 4 possesses a ring lug 43 with a ring groove 431 cut on the side wall, an O-Ring 5 seats in the ring groove 431 to provide sealing contact with the male swivel connector 1. Thus the male swivel connector 1 can rotate around the axis freely without water leakage.

1. A hose connector comprised of a male swivel connector, a socket joint and a washer; the said male swivel connector and said washer are placed into said socket joint with the flange portion, wherein a metal sleeve is put over the flange portion of the male swivel connector under said washer, and an O-ring is set between the male swivel connector and the metal sleeve.

2. A hose connector as claimed in claim 1, wherein said metal sleeve possesses a settlement for fitting the upper portion of the male swivel connector.

3. A hose connector as claimed in claim 2, wherein the depth of settlement of said metal sleeve should be bigger than the thickness of the flange portion of the male swivel connector.

4. A hose connector as claimed in claim 2, wherein said flange portion of the male swivel connector is cut into a ring groove on the outside wall contacting with the metal sleeve.

5. A hose connector as claimed in claim 2, wherein said metal sleeve possesses a ring lug with a ring groove cut on the side wall for matching with the male swivel connector.
